(19) United States
(12) Patent Application Publication
(10) Pub. No.: US 2010/0056009 A1
(43) Pub. Date: Mar. 4, 2010

(54) METHOD FOR FABRICATING FIELD EMISSION DISPLAY

(75) Inventors: TZE-YUAN WANG, Tu-Cheng (TW); CHIA-SHOU CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXCONN TECHNOLOGY CO., LTD., Tu-Cheng (TW)

(21) Appl. No.: 12/275,208

(22) Filed: Nov. 20, 2008

(30) Foreign Application Priority Data
Apr. 9, 2008 (CN) 200810066296.1

(51) Int. Cl. H01J 9/00; H01J 9/02

(52) U.S. Cl. 445/24; 445/50; 977/842

(57) ABSTRACT

A method for fabricating a carbon nanotube-based field emission display includes providing a substrate, forming a cathode array on the substrate, forming a catalyst layer on the cathode array of the substrate by self-assembly of catalyst powders onto the cathode array, growing carbon nanotubes from the cathode array of the substrate, forming an insulating layer on an area of the substrate bearing no cathode array, forming a grid array on the insulating layer of the substrate; and packaging the substrate with a phosphor screen to form the field emission display.

### BACKGROUND

1. Field of the Disclosure

The disclosure generally relates to field emission displays and, particularly, to a method for fabricating a carbon nanotube-based field emission display.

2. Description of Related Art

Field emission displays are well known in the art and are widely used since they have a small volume, low power consumption, high contrast ratio, wide viewing angle and are suitable for mass production. Generally, carbon nanotubes are widely used in field emission displays, emitting electrons from tip ends thereof to impinge on a phosphor screen and produce an image. The nanotubes are popular due to excellent mechanical properties, high electrical conductivity, and nano-size tips.

A conventional method for fabricating the carbon nanotubes of the field emission display includes forming a plurality of cathode electrodes on a substrate, forming a catalyst layer on the cathode electrodes, and growing carbon nanotubes on the cathode electrodes. However, normal deposition of the catalyst layer on the cathode electrodes by e-beam evaporation or sputtering presents difficulty in controlling uniformity of catalyst layer density, with parts of the cathode electrode receiving more catalyst powder than others. The disuniformity may finally impair field emission performance of the carbon nanotubes and reduce product lifetime of the field emission display.

For the foregoing reasons, there is a need in the art for a method of fabricating a carbon nanotube-based field emission display which overcomes the limitations described.

### SUMMARY

According to an embodiment of the disclosure, a method for fabricating a carbon nanotube-based field emission display includes providing a substrate, forming a cathode array on the substrate, forming a catalyst layer on the cathode array of the substrate by self-assembly of catalyst powders, growing carbon nanotubes from the cathode array of the substrate, forming an insulating layer on an area of the substrate bearing no cathode array, forming a grid array on the insulating layer of the substrate, and packaging the substrate with a phosphor screen to form the field emission display.

Other advantages and novel features of the disclosure will be drawn from the following detailed description of the exemplary embodiments of the disclosure with attached drawings.

### BRIEF DESCRIPTION OF THE DRAWINGS

FIG. 1 is a cross-section of a carbon nanotube-based field emission display.

FIG. 2 is flowchart of a method for fabricating the field emission display of FIG 1.

FIG. 3 shows a cathode array formed on a substrate of the light emission display.

FIG. 4 shows formation of a catalyst layer on the cathode array of the substrate by self-assembly.

FIG. 5A shows the catalyst layer formed on the cathode array having a uniform density.

FIG. 5B shows an insulating layer formed on the substrate of FIG. 5A.

FIG. 6 shows carbon nanotubes growing from the substrate of FIG. 5A.

FIG. 7 shows carbon nanotubes growing from the substrate of FIG. 5B after the insulating layer is formed or an insulating layer formed on the substrate of FIG. 6 after the carbon nanotubes are formed.

FIG. 8 shows a gate array formed on the insulating layer of the substrate of FIG 7.

### DETAILED DESCRIPTION OF THE EMBODIMENTS

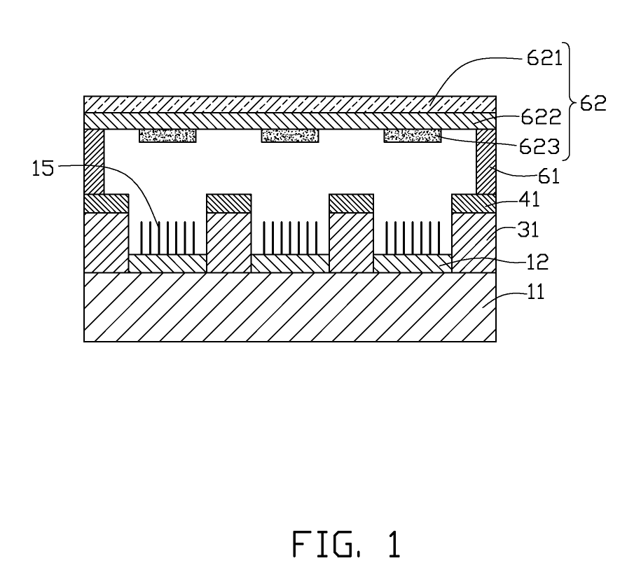

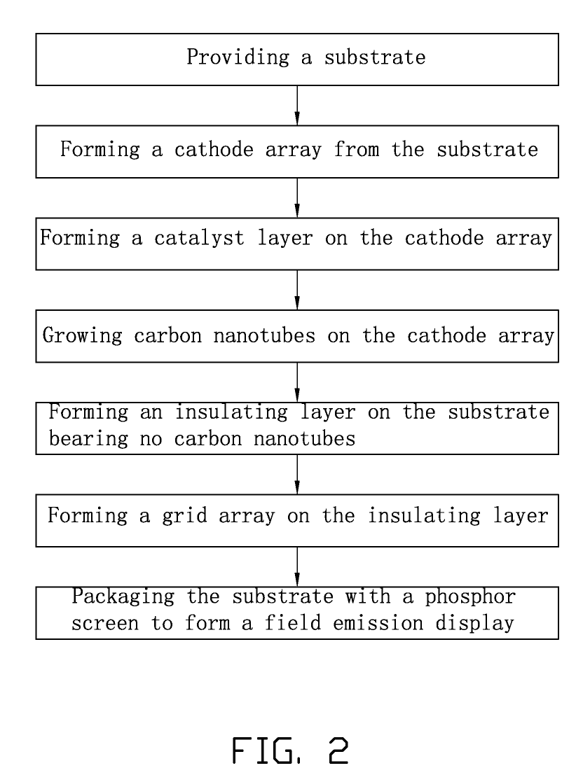

Referring to FIG. 1, a cross section of a field emission display is shown. The field emission display is formed by a method shown in FIG. 2.

The field emission display includes a substrate 11 and a phosphor screen 62 assembled to the substrate 11 by a pair of sealing plates 61 arranged therebetween. A cathode array 12 and a grid array 41 is formed on an insulating layer 31 on the substrate 11, and a plurality of carbon nanotubes 15 extends upwardly from the cathode array 12 of the substrate 11. The phosphor screen 62 is arranged over the carbon nanotubes 15. The phosphor screen 62 includes a panel 621, a conducting layer 622, and a phosphor layer 623. The panel 621 is transparent material, such as glass. The conducting layer 622 is coated on an inner surface of the panel 621, and is transparent. The phosphor layer 623 is coated on an inner side of the conducting layer 622 and faces the carbon nanotubes 15. When the conducting layer 622 and the cathode array 12 are electronically connected to a positive pole and a negative pole of a power source, respectively, electrons are emitted from tip ends of the carbon nanotubes 15 and impinge on the phosphor layer 623 of the phosphor screen 62 to produce an image visible through the transparent conducting layer 622 and the panel 621 of the phosphor layer 623.

Referring to FIG. 2, the method for fabricating the field emission display includes providing a substrate and forming a cathode array thereon, forming a catalyst layer on the cathode array of the substrate, growing carbon nanotubes from the cathode array of the substrate, forming an insulating layer on the substrate, forming a grid array on the insulating layer of the substrate, and packaging the substrate with the phosphor screen to form the field emission display. Details of the method for fabricating the field emission display follow.

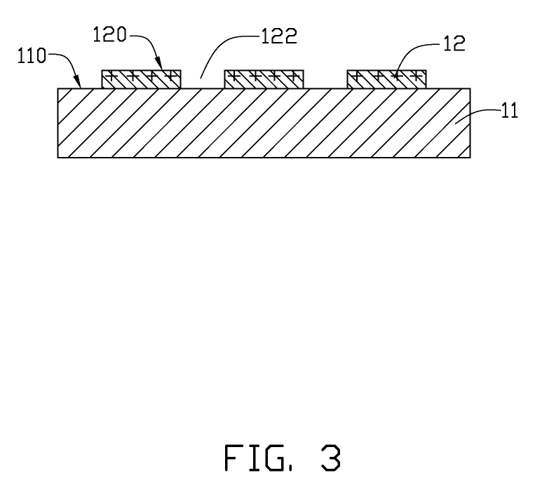

Referring to FIG. 3, a substrate 11 is provided. The substrate 11 can be glass, ceramic, silicon oxide, alumina or another suitable insulating material. A top surface 110 of the substrate 11 has a total flatness variation less than 1 micrometer. The substrate 11 is capable of withstanding temperatures at which the carbon nanotubes 15 grow, generally exceeding 700° C. A cathode array 12 is formed on the top surface 110 of the substrate 11 by electroplating or magnetic sputtering. The cathode array 12 includes a plurality of cathode electrodes distributed on the top surface 110 of the substrate 11. A gap 122 is defined between each two neighboring cathode electrodes. A top side 120 of each cathode electrode is polarized to have a positive charge.

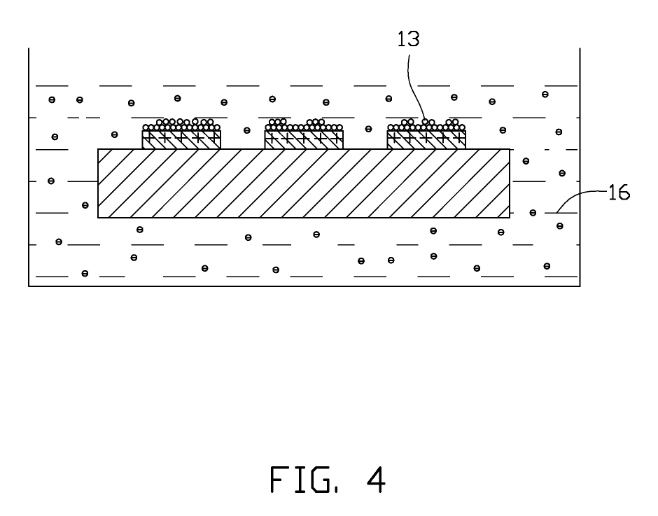

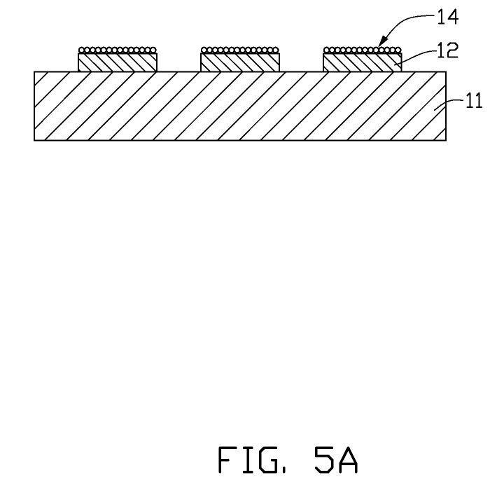

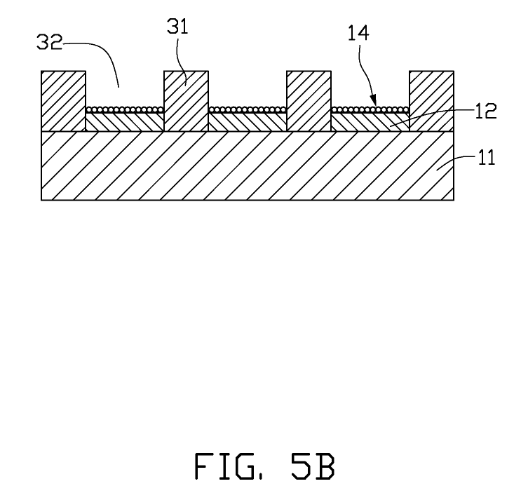

Referring to FIGS. 4 and 5A, the catalyst layer 14 can be from several tens of nanometers, and is self-assembled onto the top sides 120 of the cathode electrodes of the cathode array 12. Firstly, catalyst powders 13 are provided, and polarized with a negative charge. The catalyst powders 13 can generally be iron, cobalt, nickel, or any suitable combination alloy powders thereof. The catalyst powders 13 are dissolved into water to form a solution 16. Alternatively, a slightly acidic solution can be used to dissolve the catalyst powders 13. The substrate 11 with the cathode electrodes formed thereon is immersed in the solution 16. As the top sides 120 of the cathode electrodes have a positive charge and the catalyst powders 13 have a negative charge, under the electrostatic force, the catalyst powders 13 move and combine to the top sides 120 of the cathode electrodes automatically. In addition, the electrostatic force between the catalyst powders 13 and the cathode array 12 distributes the catalyst powders 13 evenly on the top side 120 of each cathode electrode, providing the catalyst layer 14 with a uniform density over a large area.

During the self-assembly, ultrasonic waves can be applied to vibrate the solution 16 and disperse stacked catalyst powders 13, whereby the catalyst powders 13 accurately position themselves on the top sides 120 of the cathode electrodes to form the catalyst layer 14 with highly uniform density. Alternatively, the catalyst layer 14 can be self-assembled to the cathode array 12 through spraying. In this case, the solution 16 with catalyst powders 13 is vaporized into a flow. The catalyst powders 13 in the flow self-assemble to the top sides 120 of the cathode electrodes when the flow impinges on the top sides 120 of the cathode electrodes to form the catalyst layer 14 for the electrostatic force between positive charge of the cathode array 12 and negative charge of the catalyst powders 13. Alternatively, the cathode array 12 can be polarized to a negative change, the catalyst powders 13 can be polarized to a positive charge, and the polarized catalyst powders 13 with positive charge can also self-assemble to the cathode array 12 with negative charge in reaction to electrostatic force.

Referring to FIG. 5B, an insulating layer 31 is then coated on a portion of the top surface 110 of the substrate 11 bearing no cathode array 12; that is, the insulating layer 31 is arranged in the gaps 122 between the cathode electrodes. The insulating layer 31 is much thicker than the cathode array 12, and a top end of the insulating layer 31 is higher than the catalyst layer 14. Thus a space 32 is defined in the insulating layer 31 over each cathode electrode for growing the carbon nanotubes 15. The insulating layer 31 is heatproof glass, metal coated with insulating material, silicon, silicon oxide, mica or ceramic material, capable of withstanding temperatures of about 700° C. The insulating layer 31 can be formed on the substrate 11 by coating or printing. Alternatively, the insulating layer 31 may be substituted by provision of a thin plate with spaces 32 defined therethrough.

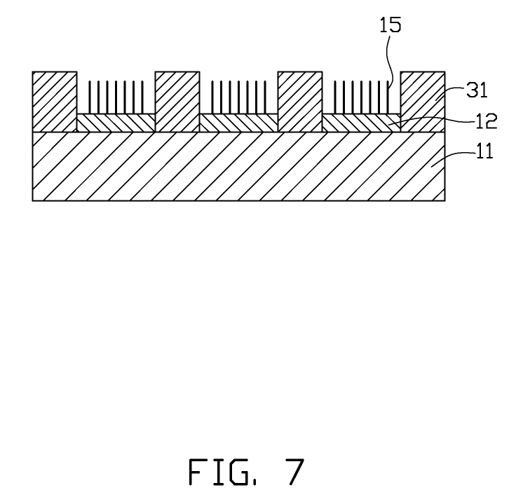

Referring to FIG. 7, the carbon nanotubes 15 are then formed within the spaces 32 by directly growing on the cathode array 12 through conventional chemical vapor deposition. A tip end of each carbon nanotube 15 is lower than the top end of the insulating layer 31. Since the catalyst layer 14 formed on the cathode array 12 by self-assembly and has a uniform density, the carbon nanotubes 15 formed on the cathode array 12 can have a uniformity of height over a large area. Therefore, a field emission performance of the carbon nanotubes 15 is enhanced and a product lifetime of the field emission display is improved.

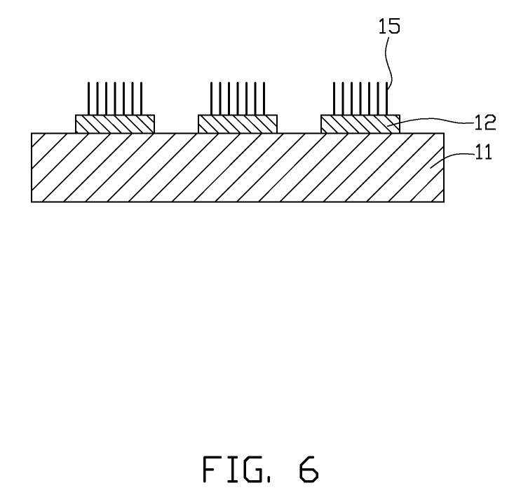

Alternatively, the carbon nanotubes 15 can be formed prior to formation of the insulating layer 31. As shown in FIG. 5A, FIG. 6, and FIG. 7, after the catalyst layer 14 is self-assembled to the cathode array 12 (FIG. 5A), the carbon nanotubes 15 are directly grown on the cathode electrodes through conventional chemical vapor deposition (FIG. 6). Finally the insulating layer 31 is formed in the gaps 122 with a top end thereof higher than the carbon nanotubes 15 (FIG. 7). Accordingly, it is understood that the sequence for forming the carbon nanotues 15 and the insulating layer 31 is arbitrary.

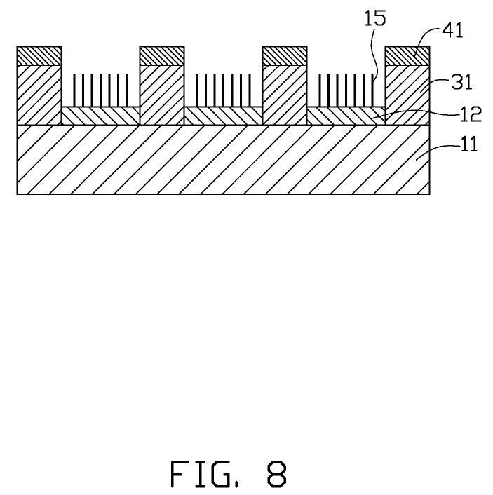

Referring to FIG. 8, after the insulating layer 31 and the carbon nanotubes 15 are formed, a grid array 41 is formed on the top end of the insulating layer 31 by e-beam evaporation, thermal evaporation or sputtering. The grid array 41 and the cathode array 12 are insulated from each other by the insulating layer 31. The grid array 41 controls a density of electrons emitted from the carbon nanotubes 15 onto the phosphor screen 62. Finally the substrate 11 with the cathode array 12, the grid array 41 and the carbon nanotubes 15 formed thereon is assembled to the phosphor screen 62 by the sealing plates 61 to form the field emission display.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A method for fabricating a carbon nanotube-based field emission display, comprising:
providing a substrate;
forming a cathode array on the substrate;
forming a catalyst layer on the cathode array of the substrate by self-assembly of catalyst powders onto the cathode array;
growing carbon nanotubes from the cathode array of the substrate;
forming an insulating layer on an area of the substrate bearing no cathode array;
forming a grid array on the insulating layer of the substrate; and
packaging the substrate with a phosphor screen to form the field emission display.

2. The method of claim 1, wherein before the catalyst layer self-assembles onto the cathode array, the catalyst powders and the cathode array are polarized to carry opposing charges.

3. The method of claim 2, wherein the polarized catalyst powders are dissolved into fluid and the polarized substrate is immersed therein, whereby the catalyst powders self-assemble to the cathode layer automatically to form the catalyst layer by electrostatic force.

4. The method of claim 3, wherein ultrasonic waves are supplied to initiate vibration of the fluid during self-assembly.

5. The method of claim 2, wherein the polarized catalyst powders are dissolved into fluid, and the fluid is vaporized into a flow, whereby the catalyst powders self-assemble onto the cathode array to form the catalyst layer by electrostatic force when the flow is sprayed onto the cathode array.

6. The method of claim 2, wherein the catalyst powders carry a negative charge, and the cathode array carries a positive charge.

7. The method of claim 2, wherein the catalyst powders carry a positive charge, and the cathode array carries a negative charge.

8. The method of claim 1, wherein the step of growing carbon nanotubes and the step of forming an insulating layer are exchanged.

9. The method of claim 1, wherein formation of the grid array is accomplished by e-beam evaporation, thermal evaporation, or sputtering.

10. A method for growing carbon nanotubes for fabricating a carbon nanotube-based field emission display, comprising:
providing a substrate;
forming a cathode array on the substrate and polarizing the cathode array;
providing catalyst powders and polarizing the catalyst powders to carry an opposite charge from the polarized cathode array;
forming a catalyst layer by self-assembly of the catalyst powders onto the cathode array by electrostatic force between the polarized cathode array and catalyst powders; and
growing carbon nanotubes from the cathode array of the substrate.

11. The method of claim 10, wherein the polarized catalyst powders are dissolved into fluid and the polarized substrate is immersed in the fluid, whereby the catalyst powders self-assemble onto the cathode layer automatically.

12. The method of claim 11, wherein ultrasonic waves are applied to vibrate the fluid during self-assembly.

13. The method of claim 10, wherein the polarized catalyst powders are dissolved into fluid, and the fluid is vaporized into a flow, whereby the catalyst powders self-assemble onto the cathode array to form the catalyst layer by electrostatic force when the flow is sprayed onto the cathode array.

14. The method of claim 10, wherein an insulating layer is formed on a portion of the substrate bearing no cathode array before the carbon nanotubes are grown.

15. The method of claim 10, wherein an insulating layer is formed on a portion of the substrate bearing no cathode array after the carbon nanotubes are grown.
